(19) United States
(12) Patent Application Publication
(10) Pub. No.: US 2024/0424549 A1
(43) Pub. Date: Dec. 26, 2024

(54) LOCKBOLT INSTALLATION SWAGE TOOL

(71) Applicant: NEWFREY LLC, New Britain, CT (US)

(72) Inventors: Neville MAIR, Milford, CT (US); Mikel EZCURRA, Danbury, CT (US); Tim CUMERSDALE, Nash (GB)

(73) Assignee: NEWFREY LLC, New Britain, CT (US)

(21) Appl. No.: 18/746,082

(22) Filed: Jun. 18, 2024

Related U.S. Application Data
(60) Provisional application No. 63/509,672, filed on Jun. 22, 2023.

(51) Int. Cl. B21J 15/10; B21J 15/26; F16B 19/05

(52) U.S. Cl. CPC B21J 15/105; B21J 15/26; F16B 19/05

(57) ABSTRACT

A lockbolt installation swage tool includes a collet assembly, a gear transmission assembly, and a sensor engine. The collet assembly has a multi-piece structural configuration to engage a pintail of the lockbolt. The gear transmission includes a pull shaft, an intermediate gear, a plurality of rollers, and a ring gear. The gear transmission assembly is operable to transfer rotation from an electric motor to a pull shaft that is operatively connected to the collet assembly. The sensor engine includes a plurality of sensors that include a plurality of redundant linear position sensors to detect linear positions of the pull shaft throughout its travel, one or more angle position sensors to detect angular orientations of the electric motor, and an electric current sensor to detect electric current at the electric motor.

### CROSS-REFERENCE TO RELATED APPLICATIONS

The present application claims the benefit of priority to U.S. Provisional Patent Application No. 63/509,672 (filed on Jun. 22, 2023), which is hereby incorporated by reference in its complete entirety.

### TECHNICAL FIELD

The present disclosure relates to a lockbolt installation swage tool. More specifically, the present disclosure relates to devices and methods for control of the lockbolt installation swage tool during lockbolt installation.

### BACKGROUND

A swaging tool is a mechanical power tool that proves to be handy in connecting a plurality of workpieces via a fastener. Some concerns regarding operation of the swaging tool are the stroke depth/length and pre-tightening torque of the fastener. Traditional swaging tools involve an entirely mechanical or manual process of fastening. A professional would have explicit knowledge of the usage of the traditional swaging tools to achieve an optimal outcome i.e., proper installation of the fastener. Purely mechanical swaging tools generally include a pulling mechanism controlled by a torque provided by an electric motor. The torque may be manually adjustable via a clutch collar where the clutch collar is attached to the swaging tool. The different positioning of the clutch enables it to achieve different torque settings. The torque value corresponding to each position of the clutch collar is specific, thus a user cannot always choose a torque level that meets the requirements. Should a user not choose the desired torque value, a value sufficiently close is selected. In such a case, the quality of operating skills and prior experience of the user is relied on to accomplish the work. Further, such a manual process is time-consuming and costly to implement which results in poor work efficiency.

To improve or otherwise enhance the shortcomings of manual swaging tools, electronic swaging tools have been introduced. Electronic swage tools are relatively easy to use and improve work efficiency. The electronic swaging tools are operable to detect the output torque which helps in controlling the rotation of the motor either mechanically or electrically. The detection of the output torque and further control of the motor makes it easier for any user to achieve the desired result. Existing electronic swaging tools have sometimes proven to be inaccurate and there is no provision to verify whether the fastener has been correctly installed or not. Therefore, a problem for an inexperienced user arises again as it pertains to verification or identification of an installed fastener by the user.

Additional concerns occur during highly-repetitive manual swaging operations in which there are variabilities in the workpiece thickness and/or the fastener size (e.g., length), which serve to make the swaging operation time-consuming, and also creates a risk in destruction of the electronic swaging tools.

### SUMMARY

The present disclosure relates to a power installation tool, such as, for example, a lockbolt installation swage tool having control architecture that enables quick and efficient installation of a fastener. In one or more example embodiments the power installation tool is operable between different operating modes.

In accordance with one or more embodiments, an example power installation tool may include one or more of the following: a housing having a handle with a trigger member; an anvil member having an opening extending along a central axis, a collet assembly disposed in the opening and extending along the central axis to grip a lockbolt in relation to the anvil member; a pull shaft extending along the central axis for connection to the collet assembly; an electric motor for activation by user-engagement of the trigger member; a gear transmission assembly driven by the electric motor to advance the pull shaft along the central axis; a user interface operable to receive one or more user input values related to characteristics of the workpiece, fastener, and the power installation tool; one or more sensors to detect the position of the pull shaft, rotation of the electric motor, and electric current to the electric motor as sensor data; and a motor controller including a processor operable to conduct analysis of the sensor data, and then control the electric motor based on the sensor analysis. The sensor analysis may include, but is not limited to, determining a travel distance to advance the pull shaft, calculating a required number of rotations of the electric motor to advance the pull shaft the travel distance, and then control the electric motor by causing it to rotate the calculated number of rotations.

In a first or manual operating mode, values for the workpiece thickness and the fastener length are known (i.e., minimal, if any, variability in the workpiece thickness and/or the fastener size). When (or before) the lockbolt installation swage tool is in the start position to receive a fastener, the user (via a user interface on the lockbolt installation swage tool) can input the total axial travel distance (stroke length) of the collet assembly relative to the anvil, and then proceed with the swaging operation.

In a second or automatic operating mode, the swaging operation may be highly-repetitive and has variabilities in workpiece thickness and/or fastener length. When the lockbolt installation swage tool is in the start position to receive a fastener, the user may pull the trigger to actuate an electric motor and thus, commence the swaging operation. Electric current to the electric motor is dynamically detected as the collet assembly engages the fastener and pulls the fastener axially toward the anvil member.

In accordance with one or more embodiments, an example installation tool may include one or more of the following: a housing having a handle with a trigger member, an anvil member connected to a forward-end portion of the housing, the anvil member having an opening extending along a central axis, a working head disposed in the opening and extending along the central axis, a pull shaft extending along the central axis and connected to a proximal end of the working head, the pull shaft having a helically-geared outer surface at a proximal end, an electric motor disposed in the housing and activated by the trigger member, and a gear transmission assembly coupled to the electric motor, the gear transmission assembly being operable to transmit rotation from the electric motor to translate the pull shaft along the central axis; the gear transmission assembly including a plurality of identical rollers uniformly distributed around the pull shaft, each roller having a helically-geared outer surface engaging or interacting with the helically-geared outer surface of the pull shaft to translate the pull shaft and connected working head along the central axis.

In accordance with one or more embodiments, an example lockbolt installation swage tool may include one or more of the following: a housing having a handle with a trigger member, an anvil member connected to a forward-end portion of the housing, the anvil member having an opening extending along a central axis, a collet assembly disposed in the opening and extending along the central axis, the collet assembly being operable to grip a pintail of a lockbolt in relation to the anvil member, a pull shaft extending along the central axis and drivably connected to the collet assembly, an electric motor disposed in the housing and activated by the trigger member, a gear transmission assembly coupled to the electric motor and operable to transmit rotation from the electric motor to translate the pull shaft and connected collet assembly along the central axis for swaging a lockbolt, an operator input unit operable to receive a user input, and a motor controller including a processor operable to receive the user input from the operator input unit, determine a distance to translate the pull shaft based on the user input, calculate a number of motor rotations required to translate the distance, and activate the electric motor for the number of rotations for the calculated distance.

In accordance with one or more embodiments, an example lockbolt installation swage tool may include one or more of the following: a housing having a handle with a trigger member, an anvil member connected to a forward-end portion of the housing, the anvil member having an opening extending along a central axis, a collet assembly disposed in the opening and extending along the central axis, the collet assembly being operable to grip a pintail of a lockbolt in relation to the anvil member, the collet assembly including three integrally separate collet members positioned concentrically around the central axis, the collet members together defining a distal opening, a pull slot proximal to the opening, and an expander receptacle proximal to a pull slot, an insert made of resilient material retained in the expander receptacle, a pull shaft extending along the central axis and connected to the collet assembly, an electric motor disposed in the housing and activated by the trigger member, and a gear transmission assembly coupled to the electric motor and operable to transmit rotation from the electric motor to translate the pull shaft and connected collet assembly along the central axis for swaging a lockbolt.

In accordance with one or more embodiments, an example lockbolt installation swage tool may include one or more of the following: an anvil member; a pull shaft movable along the central axis for connection to the working head; an electric motor; and a motor controller to control the electric motor, the motor controller including one or more processors and a non-transitory memory coupled to the one or more processors, the non-transitory memory including a set of instructions of computer-executable program code, which when executed by the one or more processors, cause the motor controller to: capture one or more of sensor data, lockbolt installation swage tool data, fastener data to be installed by the lockbolt installation swage tool, and workpiece data, detect a change in magnitude of electric current at the electric motor, and calculate, based on the detection, a required number of rotations of the electric motor to translate the pull shaft a predetermined travel distance, and control the electric motor to rotate the calculated number of rotations to complete swaging of the fastener (i.e., a lockbolt collar member on a lockbolt pin member).

### DRAWINGS

The various advantages of the embodiments of the present disclosure will become apparent to one skilled in the art by reading the following specification and appended claims, and by referencing the following drawings in which:

FIG. 1 illustrates a top perspective view of a lockbolt installation swage tool, in accordance with one or more embodiments set forth and described herein.

FIG. 2 illustrates a cross-sectional view of a lockbolt installation swage tool, in accordance with one or more embodiments set forth and described herein.

FIG. 3A illustrates a top perspective view of a collet assembly of a lockbolt installation swage tool, in accordance with one or more embodiments set forth and described herein.

FIG. 3B illustrates an exploded view of the collet assembly of FIG. 3A, in accordance with one or more embodiments set forth and described herein.

FIG. 4 illustrates a sectional view of a lockbolt installation swage tool, in accordance with one or more embodiments set forth and described herein.

FIG. 5 illustrates a sectional view of a plurality of rollers of a lockbolt installation swage tool, in accordance with one or more embodiments set forth and described herein.

FIG. 6 illustrates a sectional view of a sensor engine of a lockbolt installation swage tool, in accordance with one or more embodiments set forth and described herein.

FIG. 7 illustrates a rear elevational view of the lockbolt installation swage tool, in accordance with one or more embodiments set forth and described herein.

FIG. 8 illustrates a top perspective view of an example lockbolt prior to engagement with the lockbolt installation swage tool, in accordance with one or more embodiments set forth and described herein.

FIG. 9 illustrates a block diagram of a motor controller for the lockbolt installation swage tool, in accordance with one or more embodiments set forth and described herein.

FIG. 10 illustrates a block diagram of a sub-assembly of the lockbolt installation swage tool, in accordance with one or more embodiments set forth and described herein.

FIG. 11 illustrates a flowchart illustrating a method of performing a lockbolt installation, in accordance with one or more embodiments set forth and described herein.

FIG. 12 illustrates a flowchart of a computer-implemented method of operating a lockbolt installation swage tool, in accordance with one or more embodiments set forth and described herein.

### DESCRIPTION

A lockbolt has a two-piece configuration that includes a lockbolt pin member and a lockbolt collar member that swages into grooves of the lockbolt pin member. The lockbolt collar member is placed on the lockbolt pin member, which is positioned in a bore or hole to connect a pair of workpieces. The present disclosure provides a lockbolt installation swage tool to swage the lockbolt collar member into the grooves of the lockbolt pin member.

In one or more example embodiments, the lockbolt installation swage tool includes a housing having a trigger to activate an electric motor that is powered by a power source, a collet assembly, a gear transmission assembly driven by the electric motor, and a sensor engine to detect one or more characteristics of the lockbolt and the components, assemblies, and sub-assemblies of the lockbolt installation swage tool. The collet assembly comprises a plurality of independently movable collet members operable to collectively grip a pintail of the lockbolt pin member to axially move the lockbolt pin member rearwardly relative to an anvil member based on sensor data and/or one or more user inputs. The gear transmission assembly includes a pull shaft, an intermediate gear, and a ring gear having a plurality of rollers. The gear transmission assembly is operable to transmit rotation from an electric motor to the pull shaft that is operatively connected to the collet assembly. The sensor engine includes one or more position sensors to dynamically detect, during activation of the lockbolt installation swage tool, the current linear position of the pull shaft, one or more angular position sensors to dynamically detect the current angular orientation of the electric motor, and an electric current sensor to dynamically detect the current supplied to the electric motor. The position sensors include a first limit switch, a second limit switch, and one or more linear position sensors (e.g., linear potentiometers). The sensor engine is operable to detect: (i) the position of the pull shaft, (ii) the angular orientation of the electric motor, and (iii) the amount of electric current supplied to the electric motor. The dynamic detection of the structural and operation features of the lockbolt and the lockbolt installation swage tool ensures the safety of the lockbolt installation swage tool during a swaging operation.

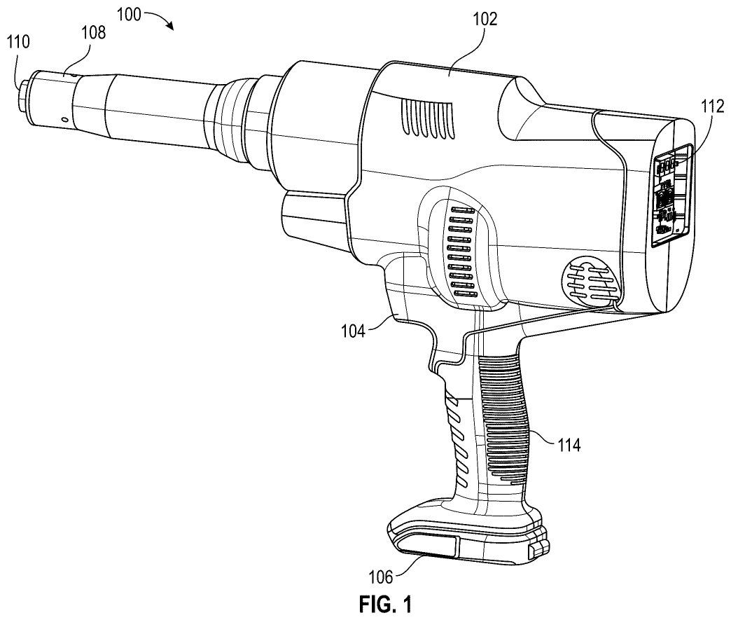

FIG. 1 illustrates a side view of a lockbolt installation swage tool 100, according to a preferred embodiment herein. The lockbolt installation swage tool 100 includes a housing 102, a trigger member 104, a battery port 106, a gear transmission assembly, an anvil member 108, a collet assembly 110, an operator input unit 112, and a handle 114. The housing 102 further includes an electric motor 202 and the gear transmission assembly. The trigger member 104 is user-engageable to actuate the electric motor 202. The battery port 106 is located at the bottom of the handle 114. The lockbolt installation swage tool 100 may be electrically powered using either a battery pack for a DC power source or a power cord as an AC power source.

Further, the gear transmission assembly includes a pull shaft 504, an intermediate gear, and a ring gear having a plurality of rollers. The collet assembly 110 is a gripping portion of the lockbolt installation swage tool 100 where a forward-end of the collet assembly 110 extends beyond the anvil member 108. The collet assembly 110 secures the pintail of the lockbolt and pulls the pintail rearwardly relative to the anvil member 108. The anvil member 108 is advanced forward relative to the collet assembly 110 to swage the lockbolt collar member into the grooves of the pintail.

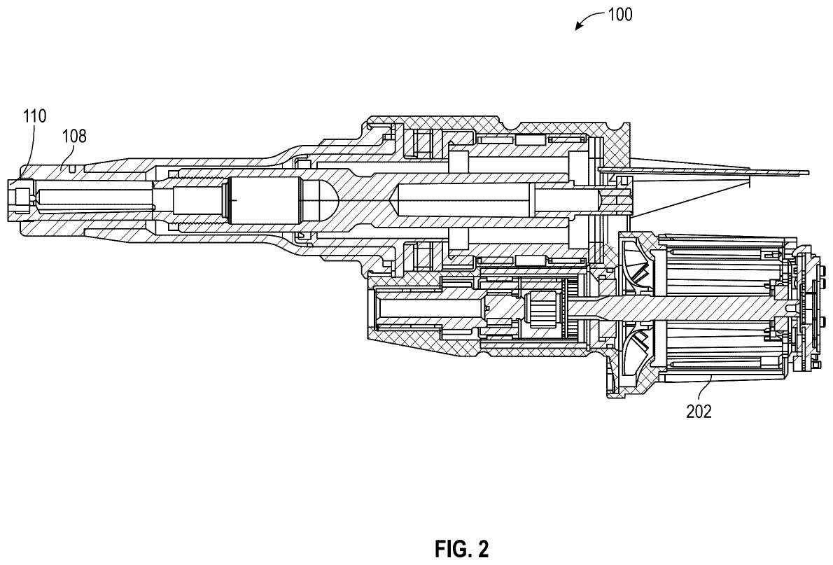

FIG. 2 illustrates a cross-sectional view of the lockbolt installation swage tool 100, in accordance with one or more embodiments set forth and described herein. The lockbolt installation swage tool 100 is operable to operate in manual mode and automatic mode. A user may need to repeatedly connect workpieces of the same thickness using lockbolts having the same length.

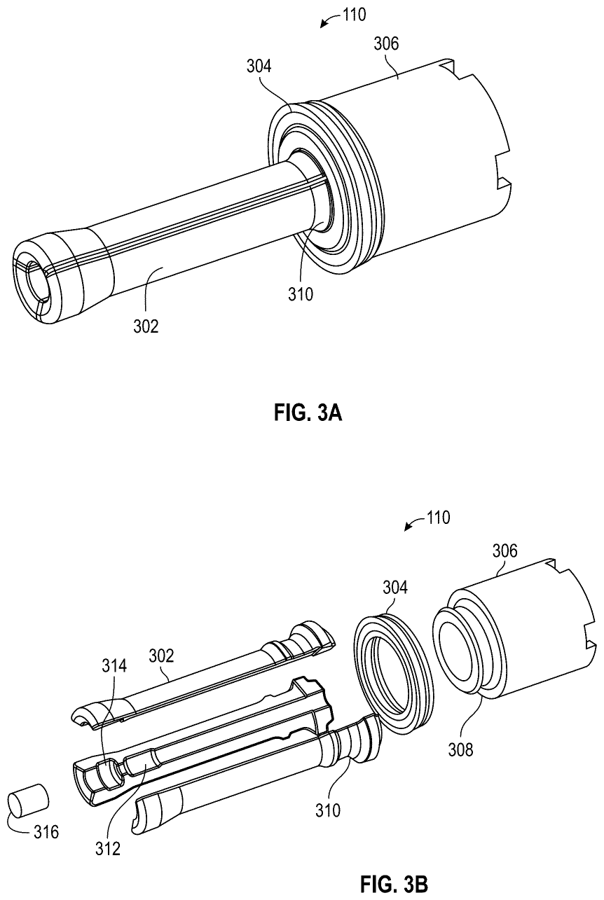

FIGS. 3A and 3B illustrate perspective and exploded views of the collet assembly 110, in accordance with one or more embodiments set forth and described herein. The collet assembly 110 comprises a multi-component configuration that includes a plurality of collet members 302, a collet bushing 304, and a collet retaining member 306. The collet members 302 assemble to form an internal chamber to closely receive the collar of the lockbolt. The collet bushing 304 is disposed between the collet members 302 and the collet retaining member 306. The collet bushing 304 rests on a base flange lock member 308 of the collet retaining member 306, thereby, permitting mounting of each of a collet member base flange 310 onto or into the base flange lock member 308 of the collet retaining member 306. When assembled as shown in FIG. 3A, collet bushing 304 and flange lock member trap each respective collet member base flange 310. A front end of each collet member 302 opposite from collet member base flange 310 cantilevers from the collet bushing 304. This cantilever enables each collet member 302 to pivot (e.g., independently relative to the other collet members) about the collet member base flange 310 and pivot relative to the collet retaining member 306. Each of the plurality of collet members 302 includes an expander receptacle 312 and a collet pull slot 314. The expander receptacle 312 is operable to receive a resilient insert 316 made of rubber, for example, to bias the collet members 302 into a normally open position. The collet pull slot 314 of the three collet members 302 define a small open cavity that engages with a pull groove of the pintail of a lockbolt to swage the lockbolt collar member on the lockbolt pin member.

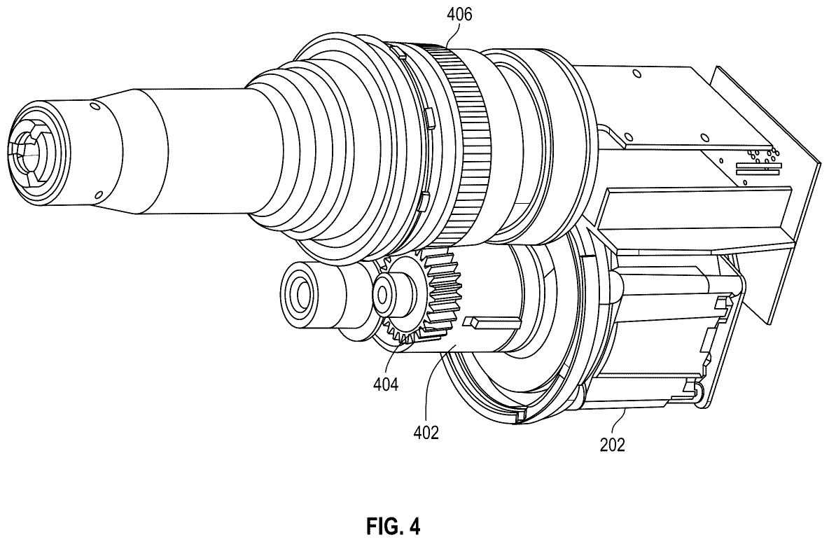

FIG. 4 illustrates a perspective view of a portion of the lockbolt installation swage tool 100, in accordance with one or more embodiments set forth and described herein. The input to the lockbolt installation swage tool 100 is provided by the user and then the user engages the trigger member 104 to activate the electric motor 202. The electric motor 202 comprises a brushless motor, however, embodiments are not limited thereto. This disclosure contemplates the electric motor 202 comprising brushed motor or any other type of motor that falls within the spirit and scope of the principles of this disclosure. The electric motor 202 is operatively connected to a planetary gear of the gear transmission assembly which is housed in planetary gear housing 402. An output gear of the planetary gear is further coupled to the intermediate gear 404 of the gear transmission assembly. The intermediate gear 404 includes external teeth engaged with the ring gear 406 of the gear transmission assembly. The intermediate gear 404 is enabled to transmit torque from the electric motor 202, through the planetary gear, to the ring gear 406 of the gear transmission assembly and, thereby, allow a rotational speed and/or torque alteration through the intermediate gear 404. The rotatory movement of the intermediate gear 404 causes the ring gear 406 to rotate at the same rotational speed as the intermediate gear 404. The rotational speed setting of the ring gear 406 may be adjusted by the user. The rotational speed setting of the ring gear 406 may be at least one of a low, medium, or high speed. One or more additional intermediate gear may be included in the drive train.

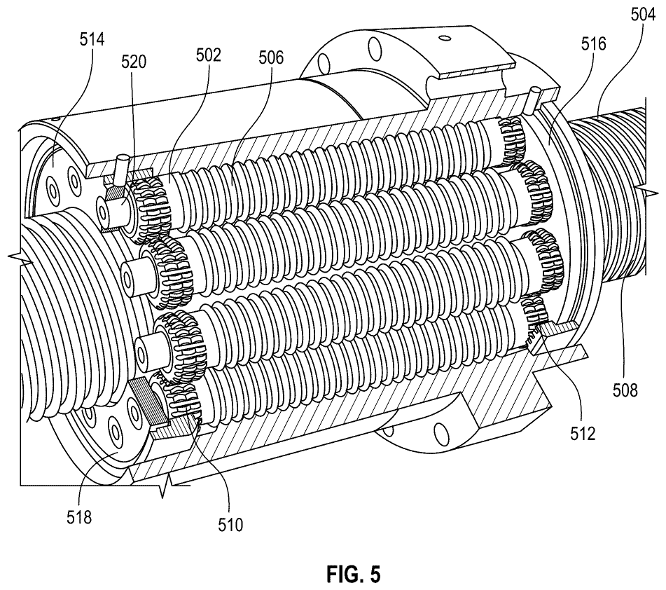

FIG. 5 illustrates a cross-sectional view of the plurality of rollers 502 of the roller screw, in accordance with one or more embodiments set forth and described herein. Roller screws are employed for converting rotational force into translational force. The rollers 502 are generally identical to each other and uniformly distributed around a pull shaft 504. An axis of each of the plurality of rollers 502 runs generally parallel to the axis of the pull shaft 504. Each of the plurality of rollers 502 includes external threads 506 that engage with external threads 508 of the pull shaft 504. Each of the plurality of rollers 502 may include outer gear teeth 510, 512 at either end. The outer gear teeth 510, 512 may be disposed axially on either side of the external threads 506 of the plurality of rollers 502. The plurality of rollers 502 receives rotational movement from the ring gear 406 that is pinned to a front washer-type ring 514 and a rear washer-type ring 516. The front washer-type ring 514 and the rear washer-type ring 516 include a plurality of holes 518 that receive either end 520 of each of the plurality of rollers 502. The ring gear 406 is operable to transmit rotational movement to the plurality of rollers 502 via the outer gear teeth 510, 512 and/or via the washer-type rings 514, 516. The rotational movement of each of the plurality of rollers 502 in the direction around pull shaft 504 and the rotational movement of each about its own individual axis in turn causes a linear translational movement of the pull shaft 504.

A conjugate profile may be employed between the outer gear teeth 510, 512 of the plurality of rollers 502 and the synchronizing gear teeth of the ring gear 406. The conjugate profile enables the transmission of uniform rotational motion due to an increase in the contact areas between the outer gear teeth 510, 512 of the plurality of rollers and the synchronizing gear teeth of the ring gear 406. Further, any chance of slip and wear is also reduced to some extent thus maximizing the output and protecting the outer gear teeth of the plurality of rollers and the synchronizing gear teeth of the ring gear from any damage.

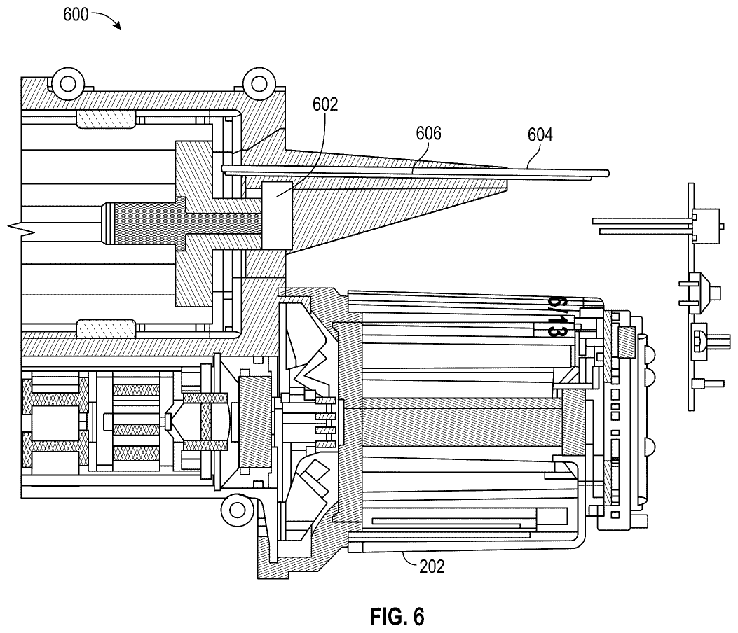

FIG. 6 illustrates a side, sectional view of the lockbolt installation swage tool 100, and includes a sensor engine 600 in communication with a motor controller 900 of the lockbolt installation swage tool 100, in accordance with one or more embodiments set forth and described herein. As used herein, “sensor” relates to any device, component and/or system that can perform one or more of detecting, determining, assessing, monitoring, measuring, quantifying, and sensing something. The sensor engine 600 includes one or more sensors operable, at least during operation of the lockbolt installation swage tool 100, to dynamically detect, determine, assess, monitor, measure, quantify, and/or sense information about the client device 100. The one or more sensors of the sensor engine 600 may be operable to detect, determine, assess, monitor, measure, quantify and/or sense in real-time. As used herein, “real-time” relates to a level of processing responsiveness that a user, module, or system senses as sufficiently immediate for a particular process or determination to be made, or that enables the processor to keep up with some external process.

The one or more sensors of the sensor engine 600 include a first limit switch 602, a second limit switch 604, a linear position sensor 606 (e.g., a potentiometer and/or Hall effect device), an angular position sensor 608 (e.g., a potentiometer and/or Hall effect device), an electric current sensor 610, and/or other elements, components, modules, systems, and subsystems of the lockbolt installation swage tool 100. Embodiments, however, are not limited thereto. This disclosure contemplates the sensor engine 600 comprising any suitable sensor architecture that permits practice of the one or more embodiments.

The first limit switch 602 and the second limit switch 604 may be placed in two different fixed positions relative to the housing 102 of the lockbolt installation swage tool 100. The placement of the first limit switch 602 and the second limit switch 604 may be based on a forward-most linear position and an aft-most linear position of the pull shaft 504. The first limit switch 602 may be placed in a location relative to the housing 102 where that location would be proximate to a target portion of the pull shaft 504 at a forward-most linear position. The second limit switch 604 may be placed in a location relative to the housing 102 where that location would be proximate to a target portion of the pull shaft 504 at its aft-most linear position. In such a manner, the lockbolt installation swage tool 100 may dynamically detect a current linear position of the pull shaft at the forward-most linear position and/or the aft-most linear position. The first limit switch 602 and the second limit switch 604 may work independently from each other, or alternatively, may work in combination with each other. The first limit switch 602 and the second limit switch 604 may be used in any combination, and may be used redundantly to validate and enhance the accuracy of the detection. One or more output signals corresponding to or otherwise representing one or more values of the detected current forward-most linear position and the detected current aft-most linear position of the pull shaft 504 (e.g., as position data) may then be transmitted by the Hall sensors to the motor controller 900.

The one or more linear position sensors 606, which may have a generally elongated structural configuration, may be operable to redundantly dynamically detect and track intermediate linear positions of the pull shaft 504 that exist between the forward-most linear position and the aft-most linear position of the pull shaft 504. One or more output signals corresponding to or otherwise representing a value of the detected current intermediate linear position of the pull shaft 504 (e.g., as intermediate linear position data) may then be transmitted by the Hall sensors to the motor controller 900.

The one or more angular position sensors 608 are operable to dynamically detect changes in the angular orientation of the rotor of the electric motor 202, and thus, provides an output signal corresponding to a calculated rotational speed and/or rotational acceleration of the electric motor 202 to the motor controller 900. In one example, the electric motor 202 may be a three-phase brushless motor having a rotor that includes a four-pole magnet. The one or more angular position sensors 608 may comprise a plurality of Hall sensors (e.g., three) positioned around the circumference of the rotor of the electric motor 202. The Hall sensors are operable to dynamically detect the angular motion of at least one of the poles of the four-pole magnet in order to dynamically detect the rotation of the rotor. One or more output signals corresponding to or otherwise representing a value of the detected angular orientation of the rotor (e.g., as angular orientation data) may then be transmitted by the Hall sensors to the motor controller 900. The motor controller 900 may then execute a calculation of the rotational speed and/or the rotational acceleration of the electric motor 202 based on the change in angular orientation of the rotor over time.

Electric current sensor 610 is operable to dynamically detect the amount or magnitude of electric current supplied to the electric motor 202. Electric current data is then transmitted to the motor controller 900 to determine any changes in electric current at the electric motor 202, and further calculate a rate of change in the amount of electric current with time during operation of the lockbolt installation swage tool 100. The sensor engine 600 advantageously provides a three-way redundancy to ensure that the gear transmission assembly is not over-torqued which would damage the lockbolt installation swage tool 100.

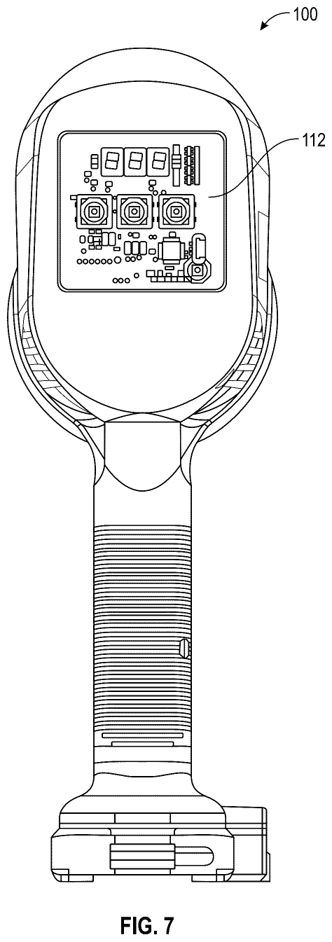

FIG. 7 illustrates a perspective view of the operator input unit 112 of the lockbolt installation swage tool 100, in accordance with one or more embodiments set forth and described herein. The operator input unit 112 comprises an input interface. As used herein, an input interface is defined as any device, software, component, system, element, or arrangement or groups thereof that enable information and/or data to be entered as one or more input command signals by a user in a manner that directs the processor to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof. The operator input unit 112 facilitates the entry of the stroke length and/or the collar height of the fastener (i.e., lockbolt) based on known fastener dimensions and workpiece thickness (e.g., such known fastener dimensions and workpiece thickness stored in memory 920). In one exemplary embodiment, the operator input unit 112 includes an LCD screen to display an inputted value of the stroke length and/or the collar height.

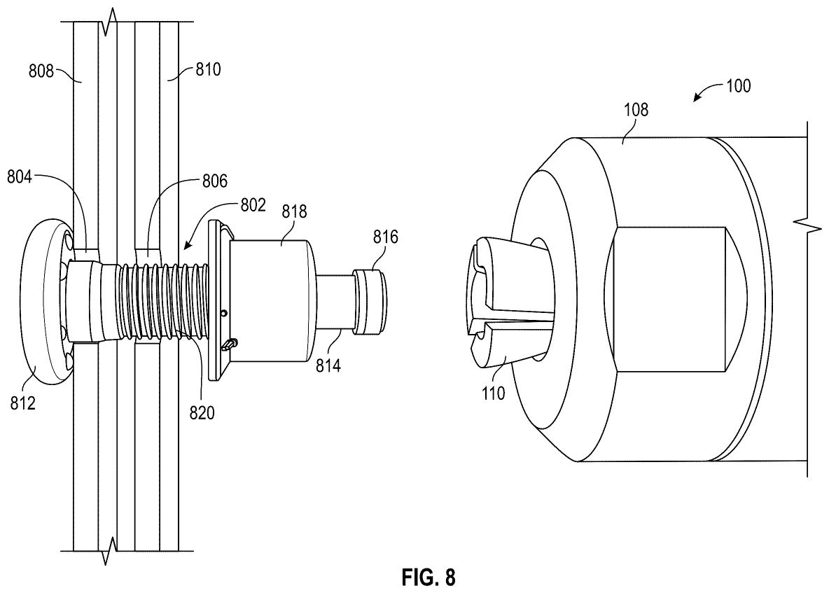

FIG. 8 illustrates a perspective view of an example lockbolt 802 prior to engagement with the lockbolt installation swage tool 100, in accordance with one or more embodiments set forth and described herein.

The collet assembly 110 of the lockbolt installation swage tool 100 extends beyond the anvil member 108 prior to engaging the lockbolt 802. The collet assembly 110 is operable to grip or otherwise engage the pintail 816 in the collet pull slot 314. Upon activation of the lockbolt installation swage tool 100, the pull shaft 504 will pull the collet assembly 110 rearwardly, causing the distal end of the collet members 302 to move from an open configuration for receiving the pintail 816 to a closed configuration for gripping the lockbolt 802. The distal end of the collet members 302 is biased in the open configuration by the rubber insert 316. In the open configuration, the distal end of the collet members 302 has a collective diameter larger than the opening in the anvil member 108.

As the collet assembly 110 is retracted through the opening in the anvil member 108, the collet members 302 will slide against the perimeter of the anvil member 108, opening into in a closed configuration to securely capture the lockbolt pintail 816. The retracting collet assembly 110 further begins pulling the lockbolt 802 rearwardly relative to the anvil member 108. The front face surface of the anvil member 108 has a diameter that is greater than the diameter of the collar 818. The anvil member includes a conical cavity that is less than an outer collar diameter operable to swage the collar 818. The anvil member 108 will contact or otherwise engage the collar 818, at which point electric current sensor 610 will detect a first change in electric current supplied to the electric motor 202. With continued movement of anvil member 108 relative to collet assembly 110, the anvil member 108 will urge/move collar 818 toward the workpiece 810. The collar 818 will in turn contact the surface of the second workpiece 810, at which point electric current sensor 610 will detect a second change in electric current that is greater than the first change. The anvil member 108 is forced down onto the collar 818 by a distance based on user input. The distance may be determined from the second change in electric current in one embodiment. The anvil member 108 is forced down onto the collar 818, causing the collar 818 to deform and further swage the collar 818 into the threaded or grooved portion 820 of the pin 814. This swaging of the collar 818 secures the collar 818 relative to the pin 814 to secure the first workpiece 808 and the second workpiece 810 together.

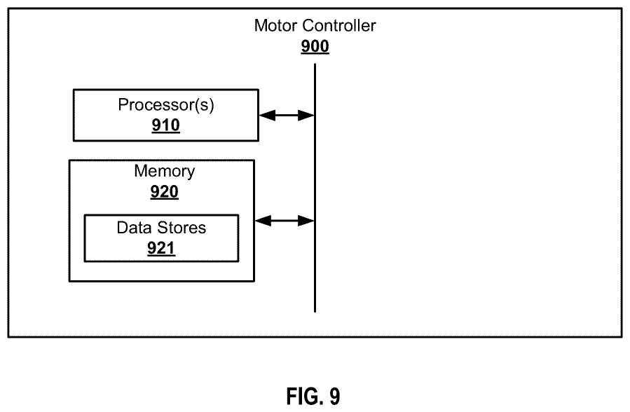

FIG. 9 illustrates a motor controller 900 for the lockbolt installation swage tool 100. The motor controller 900 includes, but is not limited to, one or more processors 910 and a non-transitory memory 920 operatively coupled to the one or more processors 910. It will be understood that it is not necessary for the motor controller 900 to incorporate all the elements illustrated in FIG. 9. For example, the motor controller 900 may have any combination of the various elements illustrated in FIG. 9. Moreover, the motor controller 900 may have additional elements to those illustrated in FIG. 9.

The one or more processors 910 may be implemented with one or more general-purpose and/or one or more special-purpose processors. Examples of suitable processors include graphics processors, microprocessors, microcontrollers, DSP processors, and other circuitry that may execute software (e.g., stored on a non-transitory computer-readable medium). Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 910 may comprise at least one hardware circuit (e.g., an integrated circuit) operable to carry out instructions contained in program code. In embodiments having a plurality of processors 910, such processors 910 may work independently from each other, or one or more processors may work in combination with each other.

The memory 920 also includes one or more data stores 921 that are operable to store one or more types of data, including but not limited to, the sensor data from the sensor engine 600, lockbolt data (e.g., lockbolt dimensions), and workpiece data (e.g., workpiece thickness). The one or more data stores 921 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 921 may be a component of the one or more processors 910, or alternatively, may be operatively connected to the one or more processors 910 for use thereby. As set forth, described, and/or illustrated herein, “operatively connected” may include direct or indirect connections, including connections without direct physical contact.

The memory 920 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by the one or more processors 910, such that the instructions, when executed by the one or more processors 910, cause the lockbolt installation swage tool 100 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

In accordance with an example embodiment, a manual mode of the lockbolt installation swage tool 100 may be used in instances when there is minimal, if any, variability in workpiece thickness and/or lockbolt size. In such an instance, the user may enter, via the operator input unit 112, a predetermined stroke length value of the pull shaft 504 (e.g., the axial distance traveled by the pull shaft) as an input signal. At this stage, the pull shaft 504 is at its aft-most position. The lockbolt pin member 814 of the lockbolt 802 may be inserted in a bore 804 of a first workpiece 808 and a bore 806 of a second workpiece 810. The lockbolt collar member 818 may then be positioned on the lockbolt pin member 814 to define a gap between the lockbolt collar member 818 and a surface of the second workpiece 810.

Next, the user places the lockbolt installation swage tool 100 on the pull groove at an aft end of the lockbolt pin member 814. The collet assembly 110 is to grip the pintail 816. Once the user pulls the trigger member 104 to actuate the electric motor 202, the anvil member 108 is caused to advance forward relative to the collet assembly 110 to thereby engage the lockbolt collar member 818. Advancement of the anvil member 108 in a forward direction thereby causes the lockbolt collar member 818 to advance forward until it engages the second workpiece 810. A spike or increase in magnitude of electric current at the electric motor 202 is detected by electric current sensor 610 once the anvil member 108 can no longer advance forward, which is indicative of a connection between the first workpiece 808 and the second workpiece 810. Responsive to the detection of the spike in electric current, the motor controller 900 controls the electric motor 202 to cause the pull shaft 504 to advance the predetermined input stroke length value, which thereby causes the anvil member 108 to advance forward to swage the lockbolt collar member 818 on the lockbolt pin member 814. The anvil member 108 then returns to its home position (i.e., by a corresponding axial movement of the pull shaft 504 to the aft-most linear position).

In accordance with an example embodiment, an automatic mode of the lockbolt installation swage tool 100 may be used in instances where there is variability in workpiece thickness and/or lockbolt size. In such an instance, the user may enter, via the operator input unit 112, the height/length of the lockbolt collar member 818 as an input value. The lockbolt pin member 814 of the lockbolt 802 may be inserted in the bore 804 of the first workpiece 808 and the bore 806 of the second workpiece 810. The lockbolt collar member 818 may then be positioned on the lockbolt pin member 814 to define a gap between the lockbolt collar member 818 and the surface of the second workpiece 810.

Next, the user places the lockbolt installation swage tool 100 on the pull groove at an aft end of the lockbolt pin member 814. The collet assembly 110 is to grip the pintail 816. Once the user pulls the trigger member 104 to actuate the electric motor 202, the anvil member 108 is caused to advance forward relative to the collet assembly 110 to thereby engage the lockbolt collar member 818. Advancement of the anvil member 108 in a forward direction thereby causes the lockbolt collar member 818 to advance forward until it engages the second workpiece 810. A spike or increase in magnitude of electric current at the electric motor 202 is detected by electric current sensor 610 once the anvil member 108 can no longer advance forward, which is indicative of a connection between the first workpiece 808 and the second workpiece 810. Responsive to the detection of the spike in electric current, the motor controller 900 calculates (based on angular position data) a required number or rotations of the electric motor 202 to advance the pull shaft 504 forward. In turn, the anvil member 108 is caused to axial translate a travel distance that corresponds to the input length of the lockbolt collar member 818.

Responsive to calculating the required rotations of the electric motor 202, the motor controller 900 controls the electric motor 202 by causing it to rotate the calculated number of rotations to cause the pull shaft 504 to advance the travel distance, which thereby causes the anvil member 108 to advance forward to swage the lockbolt collar member 818 on the lockbolt pin member 814. The anvil member 108 then returns to its home position (i.e., by a corresponding axial movement of the pull shaft 504 to the aft-most linear position). Because the length of the lockbolt collar member 818 is known (i.e., is entered by the user before the swaging operation), and the angular orientation of the electric motor 202 is dynamically detected, the number of rotations by the electric motor 202 to complete the swaging of the lockbolt collar member 818 on the lockbolt pin member 814 may be derived. In that way, the lockbolt installation swage tool 100 may quickly and accurately perform additional swaging operations (using lockbolts (e.g., lockbolt collar members) of the same length) to connect workpieces of variable thickness.

Thus, the computer-executable program code may instruct the one or more processors 910 to dynamically control the electric motor 202 in response to acquiring or otherwise capturing one or more of lockbolt data, workpiece data, lockbolt installation swage tool data (e.g., stroke length value of the pull shaft 504) and sensor data as input signals.

In one example embodiment, responsive to acquiring or otherwise capturing one or more of lockbolt data, workpiece data, and sensor data, the computer-executable program code may instruct the one or more processors 910 to dynamically calculate a distance to linearly translate or advance the pull shaft 504. The computer-executable program code may then instruct the one or more processors 910 to dynamically calculate, in response to calculating the distance to translate the pull shaft 504, a required number of rotations by the rotor of the electric motor 202 to translate the distance. Responsive to calculating the required number of motor rotations to advance the translate the pull shaft 504, the computer-executable program code may then instruct the one or more processors 910 to dynamically control the electric motor 202 to rotate the calculated rotations to complete swaging of the lockbolt collar member 818 on the lockbolt pin member 814.

In one example embodiment, responsive to acquiring or otherwise capturing electric current data during an operation of the lockbolt installation swage tool 100 in an operative state that connects adjacent workpieces), the computer-executable program code may then instruct the one or more processors 910 to dynamically determine, in response to receipt of the electric current data from electric current sensor 610, changes in electric current at the electric motor 202. Electric current data is then transmitted to the motor controller 900 to determine any changes in electric current at the electric motor 202, and further calculate a rate of change in the amount of electric current with time during operation of the lockbolt installation swage tool 100.

The computer-executable program code may then instruct the one or more processors 910 to dynamically calculate, in response to a determination of a change in current at the electric motor 202, a rate of change in current with time.

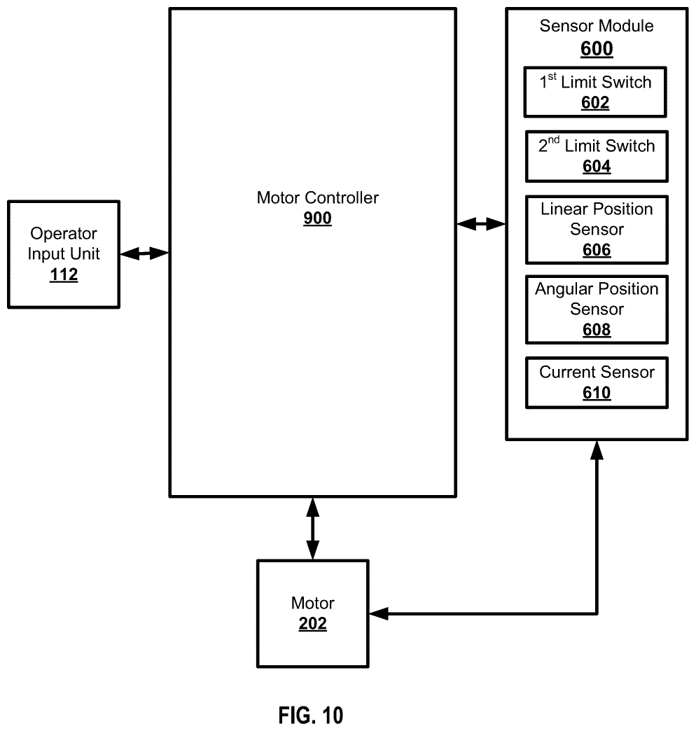

FIG. 10 illustrates a subassembly for the lockbolt installation swage tool 100. The motor controller 900 is to receive or otherwise capture lockbolt data and/or workpiece data (as one or more input command signals) from the operator input unit 112. Moreover, during operation of the lockbolt installation swage tool 100, the motor controller 900 is to also dynamically receive or otherwise capture sensor data from the first limit switch 602, the second limit switch 604, the one or more linear position sensors 606, the one or more angular position sensors 608, and the electric current sensor 610.

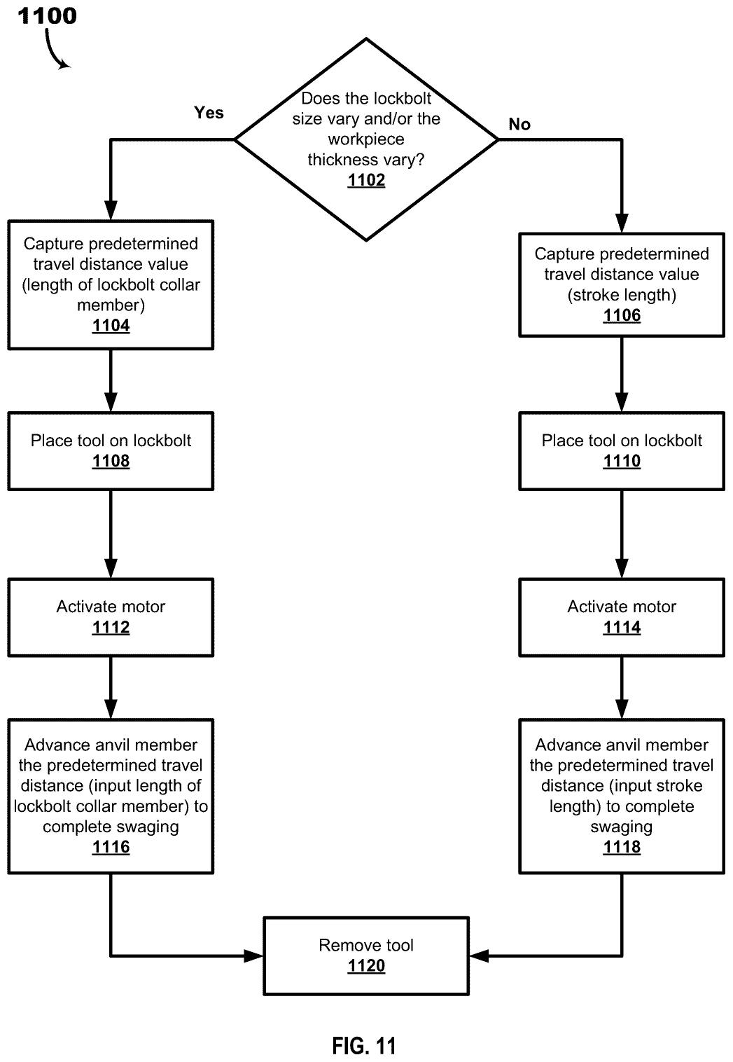

FIG. 11 illustrates a method 1100 of performing a lockbolt installation, in accordance with one or more embodiments set forth and described herein.

As illustrated in FIG. 11, illustrated decision block 1102 includes determining whether the lockbolt size (e.g., length, thickness, width, etc.) varies and/or the workpiece thickness vary.

Should it be determined that the lockbolt size and/or the workpiece thickness vary, then the method 1100 proceeds to illustrated process block 1104, which includes receiving a predetermined travel distance value that is commensurate to the height/length of the lockbolt collar member (e.g., lockbolt collar member 818) as an input signal.

The method 1100 then proceeds to illustrated process block 1108, which includes placing the lockbolt installation swage tool (e.g., lockbolt installation swage tool 100) on the lockbolt.

The method 1100 then proceeds to illustrated process block 1112, which includes activating the electric motor (e.g., electric motor 202) by pulling the trigger member (e.g., trigger member 104) of the lockbolt installation swage tool (e.g., lockbolt installation swage tool 100).

The method 1100 then proceeds to illustrated process block 1116, which includes gripping, in response to activating the electric motor, the pintail of the lockbolt with the collet assembly (e.g. collet assembly 110) in order that the anvil member (e.g., anvil member 108) of the lockbolt installation swage tool (e.g., lockbolt installation swage tool 100) advances the predetermined travel distance to complete swaging of the lockbolt collar member 818 on the lockbolt pin member 814.

The method 1100 then proceeds to illustrated process block 1120, which includes removing the lockbolt installation swage tool from the now installed lockbolt.

Should, on the other hand, it be determined that the lockbolt thickness and the workpiece thickness do not vary, then the method 1100 proceeds to illustrated process block 1106, which includes receiving a predetermined travel distance value that is commensurate to an input stroke length of the of the pull shaft (e.g., pull shaft 504) as an input signal.

The method 1100 then proceeds to illustrated process block 1110, which includes placing the lockbolt installation swage tool (e.g., lockbolt installation swage tool 100) on the lockbolt.

The method 1100 then proceeds to illustrated process block 1114, which includes activating the electric motor (e.g., electric motor 202) by pulling the trigger member (e.g., trigger member 104) of the lockbolt installation swage tool (e.g., lockbolt installation swage tool 100).

The method 1100 then proceeds to illustrated process block 1118, which includes gripping, in response to activating the electric motor, the pintail of the lockbolt with the collet assembly (e.g. collet assembly 110) in order that the anvil member (e.g., anvil member 108) of the lockbolt installation swage tool (e.g., lockbolt installation swage tool 100) advances the predetermined travel distance to complete swaging of the lockbolt collar member 818 on the lockbolt pin member 814.

The method 1100 then proceeds to illustrated process block 1120, which includes removing the lockbolt installation swage tool from the now installed lockbolt.

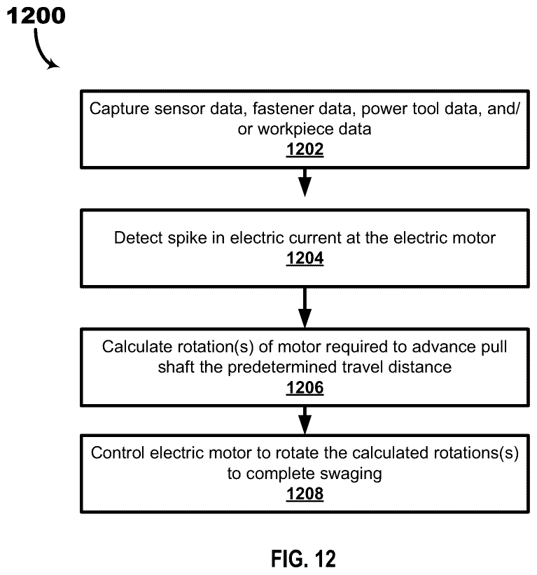

An illustrated example shown in FIG. 12 sets forth a computer-implemented method 1200. In one or more examples, the flowchart of the computer-implemented method 1200 may be implemented by the one or more processors 910 of the motor controller 900. In particular, the computer-implemented method 1200 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the motor controller 900 provides functionality described or illustrated herein. In particular, software executed by the one or more processors 910 is operable to perform one or more processing blocks of the computer-implemented method 1200 set forth, described, and/or illustrated herein, or provides functionality set forth, described, and/or illustrated.

As illustrated in FIG. 12, illustrated process block 1202 capturing, by one or more processors (e.g., one or more processors 910) of a motor controller (e.g., motor controller 900) as input signals, one or more of: sensor data, lockbolt installation swage tool data (e.g., lockbolt installation swage tool 100), fastener data (e.g., lockbolt) to be installed by the power tool, and workpiece data (e.g., such the first workpiece 808 and the second workpiece 810) to be secured together via the fastener.

In accordance with illustrated process block 1202, the captured fastener data comprises a length of the lockbolt collar member (e.g., lockbolt collar member 810).

In accordance with illustrated process block 1202, the lockbolt installation swage tool data comprises electric current data of the lockbolt installation swage tool.

In accordance with illustrated process block 1202, the lockbolt installation swage tool data comprises angular orientation data of an electric motor (e.g., electric motor 202) of the lockbolt installation swage tool.

The computer-implemented method 1200 then proceeds to illustrated process block 1204, which includes detecting (based on captured electric current data) by the one or more processors of the motor controller, during a pre-swage operating state, a spike or increase in magnitude of electric current at the electric motor (e.g., electric motor 202).

In accordance with illustrated process block 1204, the detected spike in electric current may comprise a detection of an increase in magnitude of electric current that is at or greater than a predetermined threshold electric current value.

The computer-implemented method 1200 then proceeds to illustrated process block 1206, which includes calculating, by the one or more processors of the motor controller, a required number of rotation(s) of the electric motor to advance a pull shaft (e.g., pull shaft 504) of the lockbolt installation swage tool the captured travel distance.

The computer-implemented method 1200 then proceeds to illustrated process block 1208, which includes controlling, by the one or more processors of the motor controller, the electric motor to rotate the calculated number of rotations to complete swaging of the lockbolt collar member 818 on the lockbolt pin member 814.

In accordance with illustrated process block 1208, controlling the electric motor comprises controlling a power supply to the electric motor.

### Additional Notes and Examples

Example 1 may include a fastener installation tool for installing a fastener, the fastener installation tool comprising: an anvil member having an opening extending along a central axis; a working head extending in the opening along the central axis; a pull shaft movable along the central axis for connection to the working head; an electric motor; and a gear transmission assembly operably connected to the electric motor to advance the pull shaft to translate the pull shaft along the central axis, the gear transmission assembly including a plurality of rollers distributed around the pull shaft, each roller having a helically-geared outer surface to engage the helically-geared outer surface of the pull shaft to translate the pull shaft and working head along the central axis.

Example 2 may include the fastener installation tool of Example 1, wherein the gear transmission assembly includes at least one ring gear encompassing the pull shaft and operable to transmit rotation from the electric motor to the plurality of rollers.

Example 3 may include the fastener installation tool of Example 2, wherein: each roller has distal outer gear teeth operable to engage a distal ring gear and proximal outer gear teeth operable to engage a proximal ring gear, and the helically-geared outer surface of each roller is located between the distal outer gear teeth and the proximal outer gear teeth.

Example 4 may include the fastener installation tool of Example 2, wherein the gear transmission assembly includes an intermediate gear operable to engage the at least one ring gear to transmit rotation from the electric motor to the at least one ring gear.

Example 5 may include the fastener installation tool of Example 1, wherein the working head comprises a collet assembly operable to grip and swage the fastener.

Example 6 may include the fastener installation tool of Example 1, further comprising a motor controller to control the electric motor, the motor controller including one or more processors and a non-transitory memory coupled to the one or more processors, the non-transitory memory including a set of instructions of computer-executable program code, which when executed by the one or more processors, cause the motor controller to: capture one or more of sensor data, fastener installation tool data, fastener data, and workpiece data, detect a change in magnitude of electric current at the electric motor, calculate, based on the detection, a required number of rotations of the electric motor to translate the pull shaft a predetermined travel distance, and control the electric motor to rotate the calculated number of rotations to complete swaging of the fastener.

Example 7 may include a lockbolt installation swage tool, comprising: a housing having a handle with a trigger member; an anvil member connected to a forward-end portion of the housing; the anvil member having an opening extending along a central axis; a collet assembly disposed in the opening and extending along the central axis; the collet assembly being operable to grip a pintail of a lockbolt in relation to the anvil member; a pull shaft extending along the central axis and drivably connected to the collet assembly; an electric motor disposed in the housing and activated by the trigger member; a gear transmission assembly coupled to the motor and operable to transmit rotation from the motor to translate the pull shaft and connected collet assembly along the central axis for swaging a lockbolt; an operator input unit operable to receive a user input; and a motor controller including a processor operable to receive the user input from the operator input unit, determine a travel distance to translate the pull shaft based on the user input, calculate a number of motor rotations required to translate the travel distance, and activate the motor for the number of rotations for the calculated travel distance.

Example 8 may include the fastener installation tool of Example 7, further comprising a linear position sensor operable to sense a position of the pull shaft in response to movement of the pull shaft from an initial position to an extended position.

Example 9 may include the fastener installation tool of Example 8, wherein the linear position sensor is a linear potentiometer.

Example 10 may include the fastener installation tool of Example 8, further comprising a first limit sensor and a second limit sensor operable to detect a limit of the pull shaft position in response to movement of the pull shaft from an initial position to an extended position.

Example 11 may include the fastener installation tool of Example 8, further comprising one or more angular position sensors operable to sense changes in the angular orientation of the motor and a current sensor operable to sense an amount of current being supplied to the motor.

Example 12 may include the fastener installation tool of Example 7, wherein the user input is a collar height or a stroke length of the collet assembly.

Example 13 may include the fastener installation tool of Example 7, wherein the gear transmission assembly includes a plurality of identical rollers uniformly distributed around the pull shaft; the gear transmission assembly being operable to transmit rotation from the motor to the plurality of rollers which in turn translates the pull shaft and connected collet assembly along the central axis for swaging the lockbolt.

Example 14 may include the fastener installation tool of Example 13, further comprising a ring gear operable to transmit torque from the motor to each of the plurality of rollers.

Example 15 may include a lockbolt installation swage tool, comprising: a housing having a handle with a trigger member; an anvil member connected to a forward-end portion of the housing; the anvil member having an opening extending along a central axis; a collet assembly disposed in the opening and extending along the central axis; the collet assembly being operable to grip a pintail of a lockbolt in relation to the anvil member; the collet assembly including three integrally separate collet members positioned concentrically around the central axis; the collet members together defining a distal opening, a pull slot proximal to the opening, and an expander receptacle proximal to a pull slot; an insert made of resilient material retained in the expander receptacle; a pull shaft extending along the central axis and connected to the collet assembly; an electric motor disposed in the housing and activated by the trigger member; and a gear transmission assembly coupled to the motor and operable to transmit rotation from the motor to translate the pull shaft and connected collet assembly along the central axis for swaging a lockbolt.

Example 16 may include the fastener installation tool of Example 15, further comprising a collet bushing and a collet retaining member; wherein the collet bushing is sized and operable to retain a proximal end of collet members to the collet retaining member such that the collet members are disposed between the collet bushing and the collet retaining.

Example 17 may include the fastener installation tool of Example 15, wherein the insert is operable to bias the distal end of the collet members outwardly relative to a retracted configuration in which the distal end of the collet members are disposed within the anvil member opening.

Example 18 may include the fastener installation tool of Example 17, wherein the pull slot is sized and operable to receive and grip a pintail of a lockbolt when in the retracted configuration.

Example 19 may include the fastener installation tool of Example 15, wherein the distal opening defined by the collet members is sized and operable to swage a lockbolt collar.

Example 20 may include the fastener installation tool of Example 16, wherein the collet members are independently movable with respect to the collet retaining member.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

What is claimed is:

1. A fastener installation tool for installing a fastener, comprising:
an anvil member having an opening extending along a central axis;
a working head extending in the opening along the central axis;
a pull shaft movable along the central axis for connection to the working head;
an electric motor; and
a gear transmission assembly operably connected to the electric motor to advance the pull shaft to translate the pull shaft along the central axis, the gear transmission assembly including a plurality of rollers distributed around the pull shaft, each roller having a helically-geared outer surface to engage the helically-geared outer surface of the pull shaft to translate the pull shaft and working head along the central axis.

2. The installation tool of claim 1, wherein the gear transmission assembly includes at least one ring gear encompassing the pull shaft and operable to transmit rotation from the electric motor to the plurality of rollers.

3. The installation tool of claim 2, wherein:
each roller has distal outer gear teeth operable to engage a distal ring gear and proximal outer gear teeth operable to engage a proximal ring gear, and
the helically-geared outer surface of each roller is located between the distal outer gear teeth and the proximal outer gear teeth.

4. The installation tool of claim 2, wherein the gear transmission assembly includes an intermediate gear operable to engage the at least one ring gear to transmit rotation from the electric motor to the at least one ring gear.

5. The installation tool of claim 1, wherein the working head comprises a collet assembly operable to grip and swage the fastener.

6. The fastener installation tool of claim 1, further comprising a motor controller to control the electric motor, the motor controller including one or more processors and a non-transitory memory coupled to the one or more processors, the non-transitory memory including a set of instructions of computer-executable program code, which when executed by the one or more processors, cause the motor controller to:
capture one or more of sensor data, fastener installation tool data, fastener data, and workpiece data,
detect a change in magnitude of electric current at the electric motor,
calculate, based on the detection, a required number of rotations of the electric motor to translate the pull shaft a predetermined travel distance, and
control the electric motor to rotate the calculated number of rotations to complete swaging of the fastener.

7. A lockbolt installation swage tool, comprising:
a housing having a handle with a trigger member;
an anvil member connected to a forward-end portion of the housing; the anvil member having an opening extending along a central axis;
a collet assembly disposed in the opening and extending along the central axis;
the collet assembly being operable to grip a pintail of a lockbolt in relation to the anvil member;
a pull shaft extending along the central axis and drivably connected to the collet assembly;
an electric motor disposed in the housing and activated by the trigger member;
a gear transmission assembly coupled to the motor and operable to transmit rotation from the motor to translate the pull shaft and connected collet assembly along the central axis for swaging a lockbolt;
an operator input unit operable to receive a user input; and
a motor controller including a processor operable to receive the user input from the operator input unit, determine a travel distance to translate the pull shaft based on the user input, calculate a number of motor rotations required to translate the travel distance, and activate the motor for the number of rotations for the calculated travel distance.

8. The lockbolt installation swage tool of claim 7, further comprising a linear position sensor operable to sense a position of the pull shaft in response to movement of the pull shaft from an initial position to an extended position.

9. The lockbolt installation swage tool of claim 8, wherein the linear position sensor is a linear potentiometer.

10. The lockbolt installation swage tool of claim 8, further comprising a first limit sensor and a second limit sensor operable to detect a limit of the pull shaft position in response to movement of the pull shaft from an initial position to an extended position.

11. The lockbolt installation swage tool of claim 8, further comprising one or more angular position sensors operable to sense changes in the angular orientation of the motor and a current sensor operable to sense an amount of current being supplied to the motor.

12. The lockbolt installation swage tool of claim 7, wherein the user input is a collar height or a stroke length of the collet assembly.

13. The lockbolt installation swage tool of claim 7, wherein the gear transmission assembly includes a plurality of identical rollers uniformly distributed around the pull shaft; the gear transmission assembly being operable to transmit rotation from the motor to the plurality of rollers which in turn translates the pull shaft and connected collet assembly along the central axis for swaging the lockbolt.

14. The lockbolt installation swage tool of claim 13, further comprising a ring gear operable to transmit torque from the motor to each of the plurality of rollers.

15. A lockbolt installation swage tool, comprising:
a housing having a handle with a trigger member;
an anvil member connected to a forward-end portion of the housing; the anvil member having an opening extending along a central axis;
a collet assembly disposed in the opening and extending along the central axis; the collet assembly being operable to grip a pintail of a lockbolt in relation to the anvil member; the collet assembly including three integrally separate collet members positioned concentrically around the central axis; the collet members together defining a distal opening, a pull slot proximal to the opening, and an expander receptacle proximal to a pull slot;
an insert made of resilient material retained in the expander receptacle;
a pull shaft extending along the central axis and connected to the collet assembly;
an electric motor disposed in the housing and activated by the trigger member; and
a gear transmission assembly coupled to the motor and operable to transmit rotation from the motor to translate the pull shaft and connected collet assembly along the central axis for swaging a lockbolt.

16. The lockbolt installation swage tool of claim 15, further comprising a collet bushing and a collet retaining member; wherein the collet bushing is sized and operable to retain a proximal end of collet members to the collet retaining member such that the collet members are disposed between the collet bushing and the collet retaining.

17. The lockbolt installation swage tool of claim 15, wherein the insert is operable to bias the distal end of the collet members outwardly relative to a retracted configuration in which the distal end of the collet members are disposed within the anvil member opening.

18. The lockbolt installation swage tool of claim 17, wherein the pull slot is sized and operable to receive and grip a pintail of a lockbolt when in the retracted configuration.

19. The lockbolt installation swage tool of claim 15, wherein the distal opening defined by the collet members is sized and operable to swage a lockbolt collar.

20. The lockbolt installation swage tool of claim 16, wherein the collet members are independently movable with respect to the collet retaining member.
